(19) United States
(12) Patent Application Publication
(10) Pub. No.: US 2006/0221499 A1
(43) Pub. Date: Oct. 5, 2006

(54) Thin film magnetic head and magnetic recording apparatus

(75) Inventors: Katsumichi Tagami, Chuo-ku (JP); Yuji Ito, Chuo-ku (JP); Masaru Hirose, Chuo-ku (JP); Toshiaki Maeda, Chuo-ku (JP); Nobutaka Nishio, Chuo-ku (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/340,759

(22) Filed: Jan. 27, 2006

(30) Foreign Application Priority Data
Apr. 2, 2005 (JP) 2005-028875

(51) Int. Cl. G11B 5/147

(52) U.S. Cl. 360/126

(57) ABSTRACT

The present invention provides a thin film magnetic head realizing the gradient and the strength of a perpendicular magnetic field increased as much as possible. A main magnetic pole layer is made recede from a write shield layer. As compared with the case where the magnetic pole layer is not receded from the write shield layer, an overlap range in which the main magnetic pole layer and the write shield layer are overlapped one another is smaller. Accordingly, the amount of magnetic flux emitted from the main magnetic pole layer toward a recording medium relatively increases, and the amount of magnetic flux leaked from the main magnetic pole layer to the write shield layer relatively decreases.

### BACKGROUND OF THE INVENTION

1. Field of the Invention

The present invention relates to a thin film magnetic head having at least an inductive magnetic transducer for recording and a magnetic recording apparatus on which the thin film magnetic head is mounted.

2. Description of the Related Art

In recent years, in association with increase in areal density of a magnetic recording medium (hereinbelow, simply called “recording medium”) such as a hard disk, improvement in performance of a thin film magnetic head to be mounted on a magnetic recording apparatus such as a hard disk drive (HDD) is demanded. Known recording methods of a thin film magnetic head are, for example, a longitudinal recording method in which the orientation of a signal magnetic field is set to an in-plane direction (longitudinal direction) of a recording medium and a perpendicular recording method in which the orientation of a signal magnetic field is set to a direction orthogonal to the surface of a recording medium. At present, the longitudinal recording method is widely used. However, when a market trend accompanying improvement in areal density of a recording medium is considered, it is assumed that, in place of the longitudinal recording method, the perpendicular recording method will be regarded as a promising method in future for the following reason. The perpendicular recording method has advantages such that high linear recording density can be assured and a recorded recording medium is not easily influenced by thermal fluctuations.

A thin film magnetic head of the perpendicular recording method has, mainly, a thin film coil for generating a magnetic flux for recording and a magnetic pole layer generating a magnetic field (perpendicular magnetic field) for magnetizing a recording medium in a direction orthogonal to its surface on the basis of the magnetic flux generated by the thin film coil. In the thin film magnetic head of the perpendicular recording method, the recording medium is magnetized by the perpendicular magnetic field generated in the magnetic pole layer and information is magnetically recorded on the recording medium.

Some modes of the structure of the thin film magnetic head in the perpendicular recording method have already been proposed. Concretely, for example, there is a known structure including a write shield layer for receiving part of magnetic flux emitted from the magnetic pole layer on the trailing side of a magnetic pole layer in order to make the gradient of a perpendicular magnetic field sharp and increase the strength of the perpendicular magnetic field (refer to, for example, Japanese Patent Application No. 3368247).

For example, recently, another structure is also known which includes a write shield layer partly close to a magnetic pole layer via a thin gap layer on the side close to the air bearing surface in order to steepen the magnetic field gradient of a perpendicular magnetic field and increase the magnetic field strength in association with dramatic increase in areal density of a recording medium (for example, refer to “1 Tb/in² Perpendicular Recording Conceptual Design”, M. Mallary, A. Torabi, and M. Benakli, 1st NAPMRC Technical Program, University of Miami, Jan. 7 to 9, 2002, and U. S. Pat. No. 465546).

To improve the recording performance of a thin film magnetic head of the perpendicular recording method and, more concretely, to enable a recording operation to be stably executed while keeping up with the areal density of a recording medium which is increasing, for example, it is necessary to steepen the gradient of the perpendicular magnetic field as much as possible and increase the strength of the magnetic field as much as possible. In the thin film magnetic head in the conventional perpendicular recording method, as described above, by providing the write shield layer, the gradient of the perpendicular magnetic field becomes sharper and the strength of the magnetic field increases. However, the magnetic field gradient and the magnetic field strength are not sufficient in viewpoint of stably executing the recording operation while addressing to rapid increase in the areal density, so that there is still room for improvement. Therefore, to improve the recording performance of the thin film magnetic head of the perpendicular recording method, it is desired to establish a technique capable of steepening the gradient of a perpendicular magnetic field and increasing the strength of the magnetic field as much as possible.

### SUMMARY OF THE INVENTION

The present invention has been achieved in consideration of such problems and its object is to provide a thin film magnetic head and a magnetic recording apparatus realizing the gradient and strength of a perpendicular magnetic field increased as much as possible.

A thin film magnetic head according to a first aspect of the invention includes: a thin film coil that generates magnetic flux; a magnetic pole layer which extends from a side close to a recording-medium-facing surface facing a recording medium traveling in a medium travel direction toward a side far from the recording-medium-facing surface, and generates a magnetic field for magnetizing the recording medium in a direction orthogonal to the surface of the recording medium on the basis of the magnetic flux generated by the thin film coil; and a magnetic shield layer which extends from the side close to the recording-medium-facing surface toward the side far from the recording-medium-facing surface on the front side of the medium travel direction of the magnetic pole layer, is separated from the magnetic pole layer via a gap layer on the side close to the recording-medium-facing surface, and is coupled to the magnetic pole layer via a back gap on the side far from the recording-medium-facing surface, and the magnetic pole layer recedes from the magnetic shield layer to the side far from the recording-medium-facing surface.

A thin film magnetic head according to a second aspect of the invention includes: a magnetic pole layer that generates a recording magnetic field for magnetizing a recording medium in the perpendicular direction; and a magnetic shield layer disposed on the front side in a recording medium travel direction of the magnetic pole layer, and the magnetic pole layer recedes from the magnetic shield layer to the side apart from a recording-medium-facing surface.

In the thin film magnetic head according to the first or second aspect of the invention, since the magnetic pole layer recedes from the magnetic shield layer, the overlap range in which the magnetic pole layer and the magnetic shield layer overlap one another is smaller than that in the case where the magnetic pole layer does not recede from the magnetic shield layer. In this case, firstly, a front end portion of the magnetic pole layer is not easily magnetized in a direction largely deviated from the perpendicular direction (the direction from the magnetic pole layer toward a recording medium) due to the existence of the magnetic shield layer. Consequently, the front end portion is easily magnetized in the perpendicular direction also in a state where the magnetic shield layer exists. Second, the magnetic flux attraction acts between the magnetic pole layer and the magnetic shield layer, so that the front end portion of the magnetic pole layer tends to be strongly magnetized. Third, spread of the magnetic flux emitted from the magnetic pole layer is suppressed, so that the magnetic flux tends to be emitted in the perpendicular direction. Thus, the amount of the magnetic flux emitted from the magnetic pole layer toward a recording medium increases relatively, and the amount of the magnetic flux leaked from the magnetic pole layer to the magnetic shield layer decreases relatively.

The present invention also provides a magnetic recording apparatus on which a recording medium and a thin film magnetic head for performing a magnetic process on the recording medium are mounted. The thin film magnetic head comprises: a thin film coil that generates magnetic flux; a magnetic pole layer which extends from a side close to a recording-medium-facing surface facing a recording medium traveling in a medium travel direction toward a side far from the recording-medium-facing surface and generates a magnetic field for magnetizing the recording medium in a direction orthogonal to the surface of the recording medium on the basis of the magnetic flux generated by the thin film coil; and a magnetic shield layer which extends from the side close to the recording-medium-facing surface toward the side far from the recording-medium-facing surface on the front side in the medium travel direction of the magnetic pole layer, is separated from the magnetic pole layer via a gap layer on the side close to the recording-medium-facing surface, and is coupled to the magnetic pole layer via a back gap on the side far from the recording-medium-facing surface, and the magnetic pole layer recedes from the magnetic shield layer to the side far from the recording-medium-facing surface.

Since the thin film magnetic head is mounted on the magnetic recording apparatus according to the present invention, the amount of the magnetic flux emitted from the magnetic pole layer to the recording medium increases relatively, and the amount of the magnetic flux leaked from the magnetic pole layer to the magnetic shield layer decreases relatively.

In particular, in the thin film magnetic head according to the invention, preferably, a front end of the magnetic pole layer is positioned in a range where a portion separated from the magnetic pole layer via the gap layer in the magnetic shield layer extends. The “front end of the magnetic pole layer” denotes the edge closest to the recording-medium-facing surface of the magnetic pole layer. In this case, the magnetic shield layer is exposed in the recording-medium-facing surface, and the magnetic pole layer may not be exposed in the recording-medium-facing surface. Preferably, the magnetic pole layer has an end surface which is defined by a first edge positioned on the rear side in the medium travel direction and a second edge positioned on the front side in the medium travel direction in an end portion on the side close to the recording-medium-facing surface, and width of the second edge in the end surface is larger than that of the first edge and is equal to or larger than that of the end surface in an arbitrary intermediate position between the first and second edges.

In the thin film magnetic head and the magnetic recording apparatus according to the present invention, the overlap range in which the magnetic pole layer and the magnetic shield layer overlap one another is small on the basis of the structural feature that the magnetic pole layer recedes from the magnetic shield layer. Consequently, the amount of magnetic flux emitted from the magnetic pole layer toward a recording medium increases relatively, and the amount of magnetic flux leaked from the magnetic pole layer to the magnetic shield layer decreases relatively. Therefore, the gradient and the strength of a perpendicular magnetic field can be increased as much as possible.

### BRIEF DESCRIPTION OF THE DRAWINGS

FIGS. 1A and 1B are cross sections showing a sectional configuration of a thin film magnetic head according to an embodiment of the invention.

FIG. 2 is a plan view showing a plan configuration of a main part in the thin film magnetic head illustrated in FIG. 1A and 1B.

FIG. 3 is an enlarged plan view showing a plan configuration of an end surface in a main magnetic pole layer.

FIG. 4 is a cross section for explaining advantages of the thin film magnetic head according to the embodiment of the invention.

FIG. 5 is a cross section for explaining problems of a thin film magnetic head as a comparative example of the thin film magnetic head according to the embodiment of the invention.

FIG. 6 is a plan view showing a modification of the configuration of the end surface in the main magnetic pole layer.

FIG. 7A and 7B are cross sections showing a modification of the configuration of the thin film magnetic head according to the embodiment of the invention.

FIGS. 8A and 8B are cross sections showing another modification of the configuration of the thin film magnetic head according to the embodiment of the invention.

FIG. 9 is a perspective view showing a perspective configuration of a magnetic recording apparatus on which the thin film magnetic head according to the embodiment of the invention is mounted.

FIG. 10 is an enlarged perspective view showing a perspective configuration of a main part in the magnetic recording apparatus shown in FIG. 9.

FIG. 11 is a graph showing recess height dependency of the maximum magnetic field gradient of a perpendicular magnetic field.

FIG. 12 is a graph showing recess height dependency of the gradient of the perpendicular magnetic field at a recording point.

FIG. 13 is a graph showing recess height dependency of the gradient of the perpendicular magnetic field.

FIG. 14 is a graph showing recess height dependency of the strength of a perpendicular magnetic field in the case of changing the thickness of the main magnetic pole layer.

FIG. 15 is a graph showing recess height dependency of the maximum gradient of the perpendicular magnetic field in the case of changing the thickness of the magnetic pole layer.

### DETAILED DESCRIPTION OF THE PRFERRED EMBODIMENTS

An embodiment of the invention will be described in detail hereinbelow with reference to the drawings.

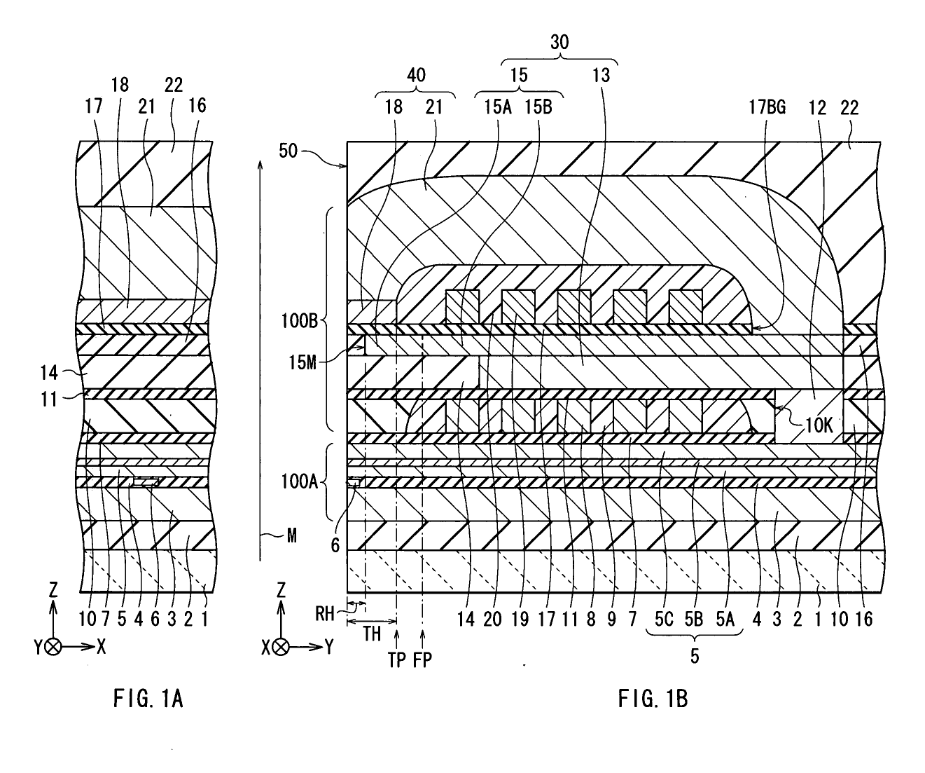

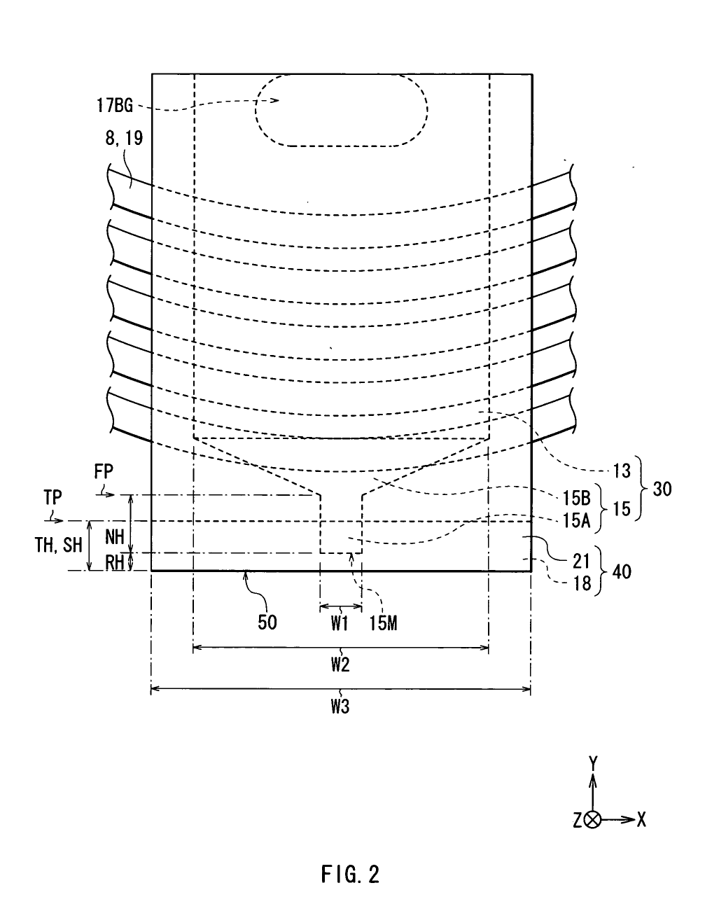

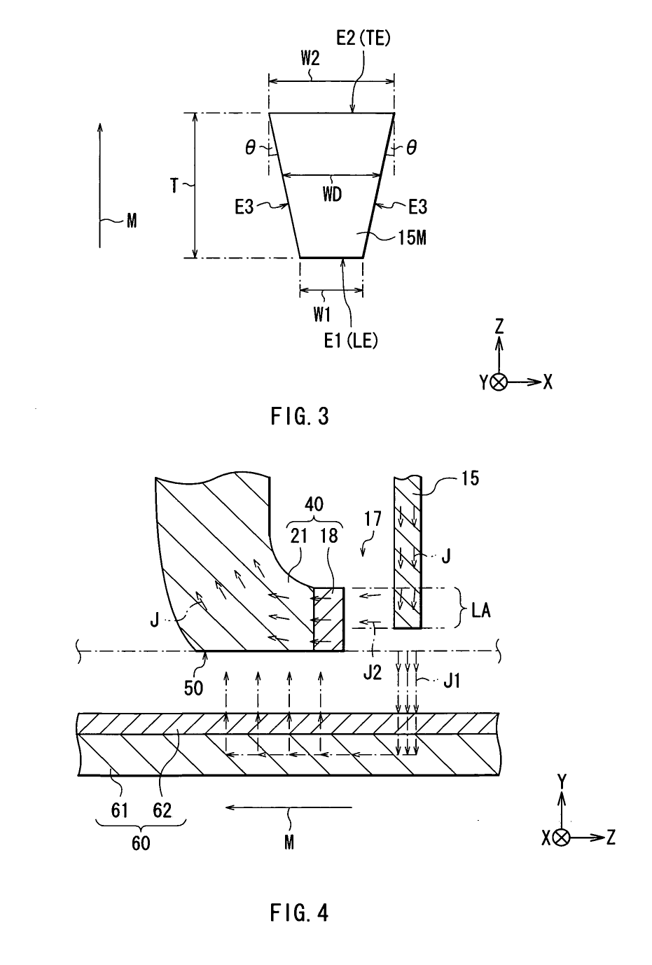

First, the configuration of a thin film magnetic head according to an embodiment of the invention will be described with reference to FIGS. 1A and 1B to FIG. 3. FIGS. 1A and 1B to FIG. 3 show a configuration of a thin film magnetic head. FIGS. 1A and 1B show a general sectional configuration. FIG. 2 shows a plan view configuration (a plan view configuration seen from the Z-axis direction) of the main part of the thin film magnetic head. FIG. 3 shows a plan view configuration (a plan view configuration seen from the Y-axis direction) of an end surface 15M of a main magnetic pole layer 15. FIG. 1A shows a sectional configuration parallel to an air bearing surface 50 (a sectional configuration along an XZ plane) and FIG. 1B shows a sectional configuration perpendicular to the air bearing surface 50 (a sectional configuration along a YZ plane). An upward arrow M shown in FIGS. 1B indicates the traveling direction of a recording medium (not shown) relative to the thin film magnetic head (medium travel direction or recording medium travel direction).

In the following description, the dimension in the X-axis direction shown in FIGS. 1A and 1B to FIG. 3 will be described as “width”, the dimension in the Y-axis direction will be described as “length”, and the dimension in the Z-axis direction will be described as “thickness”. The side close to the air bearing surface 50 in the Y-axis direction will be described as “forward” and the side opposite to the forward will be described as “rearward”. The description will be similarly used in FIG. 4 and subsequent drawings.

The thin film magnetic head according to the embodiment is to be mounted on a magnetic recording apparatus such as a hard disk drive in order to perform a magnetic process on a magnetic medium such as a hard disk traveling in the medium travel direction M. Concretely, the thin film magnetic head is, for example, a composite head capable of executing both a recording process and a reproducing process as magnetic processes. As shown in FIGS. 1A and 1B, the thin film magnetic head has a stacking structure obtained by sequentially stacking, on a substrate 1 made of a ceramic material such as AlTiC (Al₂O₃.TiC), an insulating layer 2 made of a nonmagnetic insulating material such as aluminum oxide (Al₂O₃, hereinbelow, simply called “alumina”), a reproducing head portion 100A for executing a reproducing process by using a magneto-resistive (MR) effect, an isolation layer 7 made of a nonmagnetic insulating material such as alumina, a recording head portion 100B of a shield type for executing a recording process of a perpendicular recording method, and an overcoat layer 22 made of a nonmagnetic insulating material such as alumina.

The reproducing head portion 100A has a stacked layer structure in which, for example, a lower read shield layer 3, a shield gap film 4, and an upper read shield layer 5 are stacked in this order. An MR element 6 as a reproduction element is buried in the shield gap film 4 so that one end surface is exposed in a recording-medium-facing surface (air bearing surface 50) which faces a recording medium. The “air bearing surface 50” indicates a face specified on the basis of a front end face of a write shield layer 40 which will be described later, more concretely, a face including the front end face of the write shield layer 40.

The lower and upper read shield layers 3 and 5 are provided to magnetically isolate the MR element 6 from the periphery and extend rearward from the air bearing surface 50. The lower read shield layer 3 is made of, for example, a magnetic material such as nickel iron alloy (NiFe (for example, Ni: 80% by weight and Fe: 20% by weight) which will be simply called “permalloy (trademark)” hereinbelow). The upper read shield layer 5 has, for example, a stacking structure (three-layer structure) in which a nonmagnetic layer 5B is sandwiched between upper read shield layer portions 5A and 5C. Each of the upper read shield layer portions 5A and 5B is made of, for example, a magnetic material such as permalloy. The nonmagnetic layer 5B is made of, for example, a nonmagnetic material such as ruthenium (Ru) or alumina. The upper read shield layer 5 does not always have to have a stacking structure, but may have a single layer structure.

The shield gap film 4 is provided to electrically isolate the MR element 6 from the periphery and is made of, for example, a nonmagnetic insulating material such as alumina.

The MR element 6 executes a reproducing process by using giant magneto-resistive (GMR) effect, tunneling magneto-resistive (TMR) effect, or the like.

The recording head portion 100B has, for example, a stacked layer structure obtained by sequentially stacking a thin film coil 8 in a first stage buried by insulating layers 9, 10 and 11 in which an opening for magnetic coupling (a contact gap 10K) is provided and a coupling layer 12, a magnetic pole layer 30 whose periphery is buried by insulating layers 14 and 16, a gap layer 17 in which an opening for magnetic coupling (a back gap 17BG) is provided, a thin film coil 19 in a second stage buried by an insulating layer 20, and the write shield layer 40. FIG. 2 shows the thin film coils 8 and 19, the magnetic pole layer 30, and the write shield layer 40 as main parts of the recording head portion 100B.

The thin film coil 8 mainly generates the magnetic flux for suppressing leakage in order to suppress leakage of a magnetic flux for recording generated by the thin film coil 19 and is made of, for example a high-conductive material such as copper (Cu). The thin film coil 8 has, for example, as shown in FIGS. 1B and 2, a winding structure (spiral structure) that winds around the coupling layer 12 as a center. In the thin film coil 8, a current flows in a direction opposite to that in the thin film coil 19. The number of winding times (the number of turns) of the thin film coil 8 can be freely set.

The insulating layers 9 to 11 electrically isolate the thin film coil 8 from the periphery. The insulating layer 9 is provided so as to bury spaces between the turns of the thin film coil 8 and cover the periphery of the thin film coil 8. The insulating layer 9 is made of, for example, a nonmagnetic insulating material such as photoresist, spin on glass (SOG) or the like displaying flowability when heated. The insulating layer 9 is provided, for example as shown in FIG. 1B, so as to cover only a side portion of the thin film coil 8, but not to cover the top of the thin film coil 8. The insulating layer 10 is provided so as to cover the periphery of the insulating layer 9 and is made of, for example, a nonmagnetic insulating material such as alumina. The insulating layer 11 is provided so as to cover the thin film coil 8 and the insulating layers 9 and 10, and is made of, for example, a nonmagnetic insulating material such as alumina.

The magnetic pole layer 30 receives a magnetic flux for recording generated in the thin film coil 19, and executes a recording process by emitting the magnetic flux toward a recording medium. More concretely, the magnetic pole layer 30 generates a magnetic field (perpendicular magnetic field) for magnetizing a recording medium in the direction orthogonal to the surface of the recording medium on the basis of the magnetic flux for recording as a recording process in the perpendicular recording method. The magnetic pole layer 30 is positioned on the leading side of the thin film coil 19 and extends rearward from the air bearing surface 50, more concretely, to the position corresponding to the back gap 17BG. The “leading side” is an inflow side of a recording medium (the rear side in the medium travel direction M) when a traveling state of the recording medium traveling in the medium travel direction M shown in FIG. 1B is regarded as a flow and is, in this case, a lower side in the thickness direction (Z-axis direction). On the other side, an outflow side (the front side in the medium travel direction M) is called a “trailing side”0 and is an upper side in the thickness direction.

In particular, the magnetic pole layer 30 has, for example, a stacking structure obtained by stacking sequentially an auxiliary magnetic pole layer 13 whose periphery is buried by the insulating layer 14 and the main magnetic pole layer 15 whose periphery is buried by the insulating layer 16. The magnetic pole layer 30 has, that is, a two-layer configuration in which the auxiliary magnetic layer 13 is disposed on the leading side and the main magnetic pole layer 15 is disposed on the trailing side.

The auxiliary magnetic pole layer 13 functions as a main magnetic flux receiving part and is adjacent to the main magnetic pole layer 15 so as to be magnetically coupled to each other. The auxiliary magnetic pole layer 13 extends, for example, rearward from a position receding from the air bearing surface 50, concretely, to a position corresponding to the back gap 17BG. The auxiliary magnetic pole layer 13 has, as shown in FIG. 2, a rectangular shape having a width W2 in plan view. The front end of the auxiliary magnetic pole layer 13 (the edge closest to the air bearing surface 50) is, for example, receded from a flare point FP which will be described later. The auxiliary magnetic pole layer 13 is, for example, made of a magnetic material having high-saturated magnetic flux density such as permalloy or iron-cobalt-based alloy. Examples of the iron-cobalt-based alloy are iron cobalt alloy (FeCo) and iron cobalt nickel alloy (FeCoNi).

The main magnetic pole layer 15 functions as a main magnetic flux emitting part and is adjacent to the auxiliary magnetic pole layer 13 so as to be magnetically coupled. The main magnetic pole layer 15 extends, for example as shown in FIGS. 1A and 1B and FIG. 2, rearward from a position receding from the air bearing surface 50, concretely, to a position corresponding to the back gap 17G and, that is, is receded on the side farther from the air bearing surface 50 than the write shield layer 40 (the side away from the air bearing surface 50). The receding distance of the main magnetic pole layer 15 from the air bearing surface 50, that is, the distance between the front end of the main magnetic pole layer 15 (the edge closest to the air bearing surface 50) and the air bearing surface 50 is so-called “recess height RH”. In this case, for example, as described later, although the write shield layer 40 is exposed in the air bearing surface 50, the main magnetic pole layer 15 is not exposed in the air bearing surface 50, that is, the main magnetic pole layer 15 is receded from the air bearing surface 50. The recess height RH of the main magnetic pole layer 15 is about 10 nm or less, preferably, about 5 nm or less. The main magnetic pole layer 15 is made of, for example, a magnetic material having high-saturated magnetic flux density in a similar manner to the auxiliary magnetic pole layer 13. Particularly, it is preferable that the main magnetic pole layer 15 have higher saturated magnetic flux density than the auxiliary magnetic pole layer 13.

The main magnetic pole layer 15 has, for example as shown in FIG. 2, a battledore shape in plan view. Specifically, the main magnetic pole layer 15 includes, for example, in order from the side close to the air bearing surface 50, a front end portion 15A having a predetermined width W1 specifying a recording track width of a recording medium and a rear end portion 15B magnetically coupled to the back side of the front end portion 15A and having a width W2 larger than the width W1 (W2>W1) and has a structure in which the front end portion 15A and the rear end portion 15B are integrated. The width of the rear end portion 15B is, for example, uniform (width W2) in the rear side and narrows gradually toward the front end portion 15A. “The plan-view shape of the main magnetic pole layer 15” described here is, as obvious from FIG. 2, a projection shape of the main magnetic pole layer 15, that is, a shape specified by the outside edge (outline) of the main magnetic pole layer 15. The position at which the width of the main magnetic pole layer 15 increases from the front end portion 15A (the width W1) to the rear end portion 15B (the width W2), that is, the position at which the width of the main magnetic pole layer 15 starts increasing from the predetermined width W1 specifying the recording track width of the recording medium is a “flare point FP” as one of important factors for determining the recording performance of the thin film magnetic head. The distance between the flare point FP and the air bearing surface 50 is so-called “neck height NH”. The flare point FP is, for example, receded from a throat height zero position TP which will be described later.

Particularly, the main magnetic pole layer 15 has, for example as shown in FIGS. 1A and 1B to FIG. 3, the end surface 15M in the end portion on the side close to the air bearing surface 50. The end surface 15M has a height T. As shown in FIG. 3, the end surface 15M is defined by a lower edge E1 (a first edge) positioned on the leading side and an upper edge E2 (a second edge) positioned on the trailing side. More specifically, the end surface 15M is defined by the lower edge E1 (so-called a leading edge LE) having the width W1, the upper edge E2 (so-called a trailing edge TE) having the width W2, and two side edges E3 positioned on the right and left sides in the width direction (X-axis direction). In particular, in the end surface 15M, the width W2 of the upper edge E2 is larger than the width W1 of the lower edge E1 (W2>W1), and is equal to or larger than a width WD of the end surface 15M in an arbitrary intermediate position between the lower edge E1 and the upper edge E2 (W2≧WD). For example, (1) the width W2 of the upper edge E2 is larger than the width WD (W2>WD), (2) the lower edge E1 and the upper edge E2 are in parallel with each other, (3) the two side edges E3 extend linearly, and (4) the tilt angles θ of the two side edges E3 (the angles between a virtual line (Z axis) parallel with the medium travel direction M and the side edges E3) are equal to each other. Consequently, the end surface 15M has a quadrangle shape in plan view (so-called inverted trapezoidal shape which is bilaterally symmetrical) where the lower edge E1 is used as the shorter side (bottom side) of the two sides facing each other, and the upper edge E2 is used as the longer side (top side) of the two sides facing each other.

The insulating layer 14 electrically isolates the auxiliary magnetic pole layer 13 from the periphery and is made of a nonmagnetic insulating material such as alumina. The insulating layer 16 electrically isolates the main magnetic pole layer 15 from the periphery and is made of a nonmagnetic insulating material such as alumina in a manner similar to the insulating layer 14.

The gap layer 17 is provided to form a gap for magnetic isolation between the magnetic pole layer 30 and the write shield layer 40 and, is made of, for example, a nonmagnetic insulating material such as alumina or a nonmagnetic conductive material such as ruthenium. The gap layer 17 has, for example, a thickness of tens nm, preferably, about 100 nm or less.

The thin film coil 19 generates the magnetic flux for recording. In the thin film coil 19, for example, a current flows in a direction opposite to that in the thin film coil 8. The other material, thickness, and structural features of the thin film coil 19 are, for example, similar to those of the thin film coil 8.

The insulating layer 20 electrically isolates the thin film coil 19 from the periphery by burying the thin film coil 19 and is disposed on the gap layer 17 so as not to close the back gap 17BG. The insulating layer 20 is made of, for example, a nonmagnetic insulating material such as photoresist or spin on glass displaying flowability when heated. The portions around the edges of the insulating layer 20 form round slopes inclined downward to the edges. The position of the front end (the edge closest to the air bearing surface 50) of the insulating layer 20 is the “throat height zero position TP” as one of important factors determining the recording performance of the thin film magnetic head. The distance between the throat height zero position TP and the air bearing surface 50 is a so-called “throat height TH”.

The write shield layer 40 is a magnetic shield layer to collect a part (spread component) of the magnetic flux emitted from the magnetic pole layer 30, thereby steepening the gradient of a magnetic field generated on the basis of the magnetic flux. The write shield layer 40 is positioned on the trailing side of the magnetic pole layer 30 and the thin film coil 19. The write shield layer 40 extends rearward from the air bearing surface 50, is isolated from the magnetic pole layer 30 by the gap layer 17 on the side close to the air bearing surface 50, and is magnetically coupled to the magnetic pole layer 30 via the back gap 17BG on the side far from the air bearing surface 50.

The write shield layer 40, for example, includes a TH specifying layer 18 and a yoke layer 21 constructed as members separate from each other and has a structure in which the TH specifying layer 18 and the yoke layer 21 are magnetically coupled to each other.

The TH specifying layer 18 functions as a main magnetic flux receiving port and has a length SH. The TH specifying layer 18 extends, for example as shown in FIG. 1B, rearward from the air bearing surface 50 to a rearward position, concretely, to a position between the air bearing surface 50 and the thin film coil 19 while being adjacent to the gap layer 17, and is adjacent to the insulating layer 20 at the position. The TH specifying layer 18 is made of, for example, a magnetic material having high saturated magnetic flux density such as permalloy or iron-based alloy and has, as shown in FIG. 2, a rectangular shape in plan view having a width W3 larger than the width W2 of the magnetic pole layer 30 (the rear end portion 15B) (W3>W2). Since the TH specifying layer 18 is adjacent to the insulating layer 20 as described above, the TH specifying layer 18 has the role of specifying the throat height TH by specifying the front end position (throat height zero position TP) of the insulating layer 20.

The yoke layer 21 functions as a passage of the magnetic flux received from the TH specifying layer 18. The yoke layer 21 extends, for example as shown in FIG. 1B, from the air bearing surface 50 via the insulating layer 20 to at least a position corresponding to the back gap 17BG while riding on the TH specifying layer 18. Specifically, the yoke layer 21 is provided on the TH specifying layer 18, thereby being magnetically coupled to the TH specifying layer 18 in the front portion, and is adjacent to the magnetic pole layer 30 via the back gap 17BG to be magnetically coupled to the magnetic pole layer 30 in the rear portion. The yoke layer 21 is made of, for example, a magnetic material having high-saturated magnetic flux density in a manner similar to the TH specifying layer 18 and, as shown in FIG. 2, has a rectangular shape in plan view having the width W3.

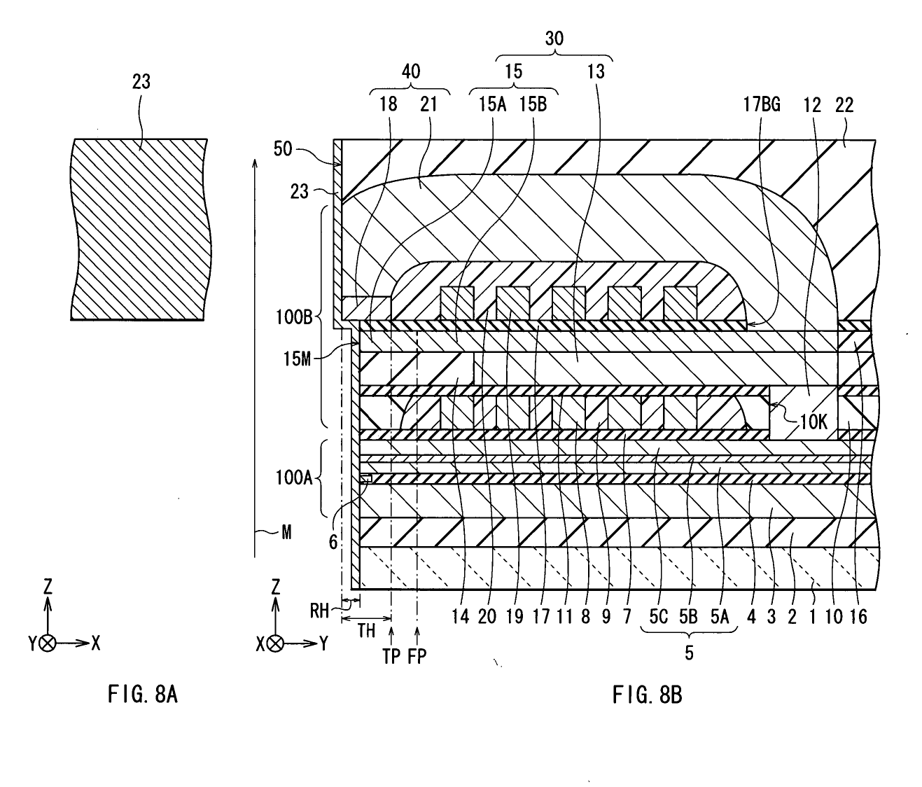

In the thin film magnetic head, as described above, the write shield layer 40 is exposed in the air bearing surface 50 and, on the other hand, the main magnetic pole layer 15 is not exposed in the air bearing surface 50, that is, the main magnetic pole layer 15 is receded from the write shield layer 40. More concretely, the front end of the main magnetic pole layer 15, that is, the position of the end surface 15M is recede from the air bearing surface 50. The description “the write shield layer 40 is exposed in the air bearing surface 50” indicates that the write shield layer 40 constructs a part of the air bearing surface 50. On the other hand, the description “the main magnetic pole layer 15 is not exposed in the air bearing surface 50” indicates that the main magnetic pole layer 15 does not construct a part of the air bearing surface 50. On the basis of the indication, the mode “the write shield layer 40 is exposed in the air bearing surface 50 and the main magnetic pole layer 15 is not exposed in the air bearing surface 50” includes, as long as the main magnetic pole layer 15 is receded from the write shield layer 40, not only the mode in which the air bearing surface 50 is exposed as shown in FIG. 1B but also a mode in which a protection film 23 is provided so as to cover the air bearing surface 50 and the periphery as shown in FIG. 8 which will be described later.

In particular, the front end of the main magnetic pole layer 15 (the edge closest to the air bearing surface 50) is positioned, for example, in a part separated from the magnetic pole layer 30 via the gap layer 17 in the write shield layer 40, that is, in a range where the TH specifying layer 18 in the write shield layer 40 extends. More concretely, the front end of the main magnetic pole layer 15 is positioned in a range of a length SH of the TH specifying layer 18.

In the thin film magnetic head, for example as shown FIGS. 1A, 1B and FIG. 2, the series of components from the substrate 1 to the overcoat layer 22 construct the air bearing surface 50, that is, the air bearing surface 50 is formed as a plane constructed by the series of components from the substrate 1 to the overcoat layer 22.

The operation of the thin film magnetic head will now be described with reference to FIGS. 1A and 1B to FIG. 3.

In the thin film magnetic head, at the time of recording information, when a current flows from a not-shown external circuit into the thin film coils 8 and 19 in the recording head portion 100B, a magnetic flux for recording is generated by the thin film coil 19. The generated magnetic flux is received by the magnetic pole layer 30 and, after that, flows toward the front end portion 15A in the main magnetic pole layer 15 inside of the main magnetic pole layer 30. Since the magnetic flux flowing in the main magnetic pole layer 15 is converged while being narrowed at the flare point FP as the width of the main magnetic pole layer 15 decreases, the magnetic flux is finally concentrated on the neighborhood of the trailing edge TE in the end surface 15M of the front end portion 15A. When the magnetic flux concentrated on the neighborhood of the trailing edge TE is emitted to the outside via the air bearing surface 50 to thereby generate a recording magnetic field (perpendicular magnetic field) in the direction (perpendicular direction) orthogonal to the surface of a recording medium, the recording medium is magnetized by the perpendicular magnetic field so that information is magnetically recorded onto the recording medium.

In particular, at the time of recording information, currents flow into the thin film coils 8 and 19 so as to be in directions opposite to each other, so that the magnetic fluxes are generated in directions opposite to each other in the thin film coils 8 and 19, respectively. Concretely, with reference to FIG. 1B, the magnetic flux (the magnetic flux for suppressing leakage) is generated upward in the thin film coil 8. On the other hand, the magnetic flux (the magnetic flux for recording) is generated downward in the thin film coil 19. Consequently, by the influence of the upward magnetic flux generated by the thin film coil 8, leakage of the downward magnetic flux generated by the thin film coil 19 from the recording head portion 100B to the reproducing head portion 100A is suppressed.

At the time of recording information, a part of the magnetic flux for recording emitted from the magnetic pole layer 30 (a spread component) is received by the write shield layer 40, so that the spread of the magnetic flux is suppressed. Consequently, the gradient of the perpendicular magnetic field becomes sharp. The magnetic flux received by the write shield layer 40 is circulated into the magnetic pole layer 30 via the back gap 17BG.

On the other hand, at the time of reproducing information, when a sense current flows into the MR element 6 of the reproducing head portion 100A, the resistance value of the MR element 6 changes according to a signal magnetic field for reproduction based on the recording medium. Therefore, by detecting the resistance change of the MR element 6 as a change in the sense current, information recorded on the recording medium is magnetically reproduced.

In the thin film magnetic head of the embodiment, the main magnetic pole layer 15 is provided so as to be receded from the write shield layer 40. Therefore, for the following reason, the gradient and the strength of the perpendicular magnetic field can be increased as much as possible.

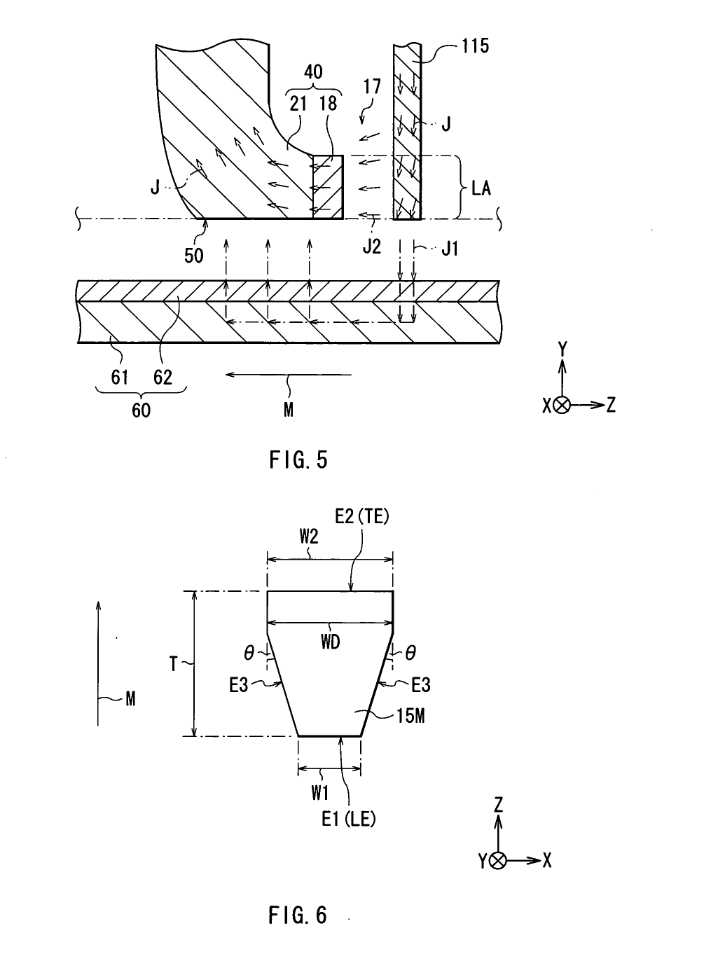

FIG. 4 is a diagram for explaining an advantage of the thin film magnetic head according to the embodiment shown in FIGS. 1A and 1B to FIG. 3. FIG. 5 is a diagram for explaining a problem of the thin film magnetic head as a comparative example of the thin film magnetic head according to the embodiment. FIGS. 4 and 5 schematically show enlarged views of only a main part of the recording head portion 100B of the thin film magnetic head. The thin film magnetic head of the comparative example shown in FIG. 5 has a structure similar to that of the thin film magnetic head according to the embodiment except for the following point. The thin film magnetic head of the comparative example has, in place of the main magnetic pole layer 15 which is receded from the write shield layer 40 (the TH specifying layer 18 and the yoke layer 21), that is, receded from the air bearing surface 50, a main magnetic pole layer 115 which is not receded from the write shield layer 40 but is exposed together with the write shield layer 40 in the air bearing surface 50. A recording medium 60 shown in FIGS. 4 and 5, on which information is magnetically recorded by the thin film magnetic head, has a stacking structure including, for example, a base layer (soft magnetic layer) 61 functioning as a passage of a magnetic flux used for a recording process and a recording layer (perpendicular magnetization layer) 62 on which information is magnetically recorded by the magnetic flux. The base layer 61 and the recording layer 62 are representative components of the recording medium 60 for perpendicular recording. Obviously, the recording medium 60 may include layers other than the base layer 61 and recording layer 62.

In the thin film magnetic head of the comparative example, as shown in FIG. 5, when a magnetic flux J for recording is received by the main magnetic pole layer 115 in a state where the air bearing surface 50 is disposed so as to face the recording medium 60, the magnetic flux J is used in order to magnetically record information on the recording medium 60 and, after that, circulated into the write shield layer 40. More concretely, most of the magnetic flux J received by the main magnetic pole layer 115, that is, magnetic fluxes emitted from the main magnetic pole layer 115 toward the recording medium 60 (emitted magnetic fluxes J1) in order to generate the perpendicular magnetic field pass through the recording layer 62 and the base layer 61 and, after that, passes again the recording layer 62 in the recording medium 60. Finally, the magnetic fluxes J are indirectly received by the write shield layer 40. The rest of the magnetic fluxes J received by the main magnetic pole layer 115, that is, magnetic fluxes leaked via the gap layer 17 (leakage magnetic fluxes J2) in a process where the magnetic fluxes flow in the main magnetic pole layer 115 are directly received by the write shield layer 40 without being emitted toward the recording medium 60 (without being used in order to generate the perpendicular magnetic field).

In the thin film magnetic head of the comparative example, an overlap range LA in which the main magnetic pole layer 115 and the write shield layer 40 overlap one another is excessive large due to the structure in which the main magnetic pole layer 115 is exposed in the air bearing surface 50 in a similar manner to the write shield layer 40. In this case, due to the phenomenon that the overlap range LA becomes excessive large in a state where the write shield layer 40 is close to the trailing side of the main magnetic pole layer 115 via the thin gap layer 17, a front end portion of the main magnetic pole layer 115 is easily magnetized in a direction largely deviated from the perpendicular direction (largely deviated to the trailing side) due to the existence of the write shield layer 40. Consequently, the front end portion in the main magnetic pole layer 115 is not easily magnetized in the perpendicular direction in a state where the write shield layer 40 exists. Accordingly, the amount of the emitted magnetic fluxes J1 emitted from the main magnetic pole layer 115 toward the recording medium 60 relatively decreases and the leakage magnetic fluxes J2 leaked from the main magnetic pole layer 115 toward the write shield layer 40 relatively increases. Therefore, in the thin film magnetic head of the comparative example, it is difficult to increase the gradient and the strength of the perpendicular magnetic field as much as possible.

On the other hand, in the thin film magnetic head of the embodiment, as shown in FIG. 4, when the magnetic flux J for recording is received by the main magnetic pole layer 15 in a state where the air bearing surface 50 is disposed so as to face the recording medium 60, in a similar manner to the case of the thin film magnetic head of the comparative example, the emitted magnetic flux J1 of the magnetic flux J received by the main magnetic pole layer 15 is indirectly received by the write shield layer 40 via the recording medium 60 and the leakage magnetic flux J2 is directly received by the write shield layer 40 without being emitted toward the recording medium 60.

In the thin film magnetic head of the embodiment, in comparison with the thin film magnetic head of the comparative example in which the main magnetic pole layer 115 is exposed in the air bearing surface 50 in a similar manner to the write shield layer 40 (refer to FIG. 5), the overlap range LA in which the main magnetic pole layer 15 and the write shield layer 40 overlap one another is smaller on the basis of the structure in which the main magnetic pole layer 15 is not exposed in the air bearing surface 50 and receded from the write shield layer 40. In this case, first, on the basis of the phenomenon that the overlap range LA becomes smaller in a state where the write shield layer 40 is close to the tailing side of the main magnetic pole layer 15 via the thin gap layer 17, the front end portion of the main magnetic pole layer 15 is not easily magnetized in a direction largely deviated from the perpendicular direction due to the existence of the write shield layer 40. Consequently, the front end portion is easily magnetized in the perpendicular direction also in a state where the write shield layer 40 exists. Second, the main magnetic pole layer 15 and the write shield layer 40 are magnetized so as to have poles different from each other. For example, in a state where the main magnetic pole layer 15 is magnetized positively and the write shield layer 40 is magnetized negatively, when the main magnetic pole layer 15 is receded from the write shield layer 40, a magnetic flux attraction action (an action of inducing the magnetic flux received by the main magnetic pole layer 15 toward the air bearing surface 50) occurs between the main magnetic pole layer 15 and the write shield layer 40. Consequently, the magnetic flux tends to be concentrated on the front end portion in the main magnetic pole layer 15 on the basis of the magnetic flux attraction action. That is, the front end portion is easily magnetized strongly. Third, as described above, on the basis of the phenomenon that the leakage magnetic flux J2 leaked from the main magnetic pole layer 15 is received by the write shield layer 40 before reaching the air bearing surface 50, the spread of the emitted magnetic flux J1 emitted from the main magnetic pole layer 15 is suppressed, so that the emitted magnetic flux J1 tends to be emitted in the perpendicular direction. As a result, the amount of the emitted magnetic flux J1 from the main magnetic pole layer 15 toward the recording medium 60 relatively increases and the amount of the leakage magnetic flux J2 leaked from the main magnetic pole layer 15 to the write shield layer 40 relatively decreases. Therefore, in the thin film magnetic head of the embodiment, the gradient and the strength of the perpendicular magnetic field can be increased as much as possible.

Particularly, in the embodiment, the front end of the main magnetic pole layer 15 is positioned in a range where a portion separated from the magnetic pole layer 30 via the gap layer 17 in the write shield layer 40 extends. Consequently, as shown in FIG. 4, the overlap range LA is always assured between the main magnetic pole layer 15 and the write shield layer 40. In the case, the overlap range LA is assured so that the amount of the leakage magnetic flux J2 does not excessively increase due to the magnetization direction of the main magnetic pole layer 15 as described above and the amount of the emitted magnetic flux J1 does not decrease extremely due to excessive receding of the main magnetic pole layer 15 from the air bearing surface 50. Accordingly, also from the viewpoint, the gradient and the strength of the perpendicular magnetic field can be increased.

In the embodiment, the end surface 15M of the main magnetic pole layer 15 emitting the magnetic flux to generate the perpendicular magnetic field has an inverted trapezoidal shape which is bilaterally symmetrical in plan view. Consequently, even if a skew occurs in a recording operation of the thin film magnetic head, that is, the main magnetic pole layer 15 is inclined from the tangential direction of a track to be recorded (a specific track on which information is to be recorded) which is provided in a curved line shape in the recording medium, the end surface 15M in the main magnetic pole layer 15 does not go off the track to be recorded to an adjacent track (another track adjacent to the track to be recorded). In the case, different from the case where the end surface 15M goes off the track to be recorded into the adjacent track when the skew occurs due to the structural factor that the end surface 15M has a rectangular shape in plan view, magnetization of not only the track to be recorded but also the adjacent track by the perpendicular magnetic field is suppressed. Consequently, unintentional erasure of information recorded on the recording medium due to a skew can be suppressed in information recording.

In the embodiment, the thin film coil 19 which generates the magnetic flux for recording is provided on the trailing side of the main magnetic pole layer 15, and the thin film coil 8 which generates the magnetic flux for suppressing leakage is also provided on the leading side of the main magnetic pole layer 15 in order to suppress leakage of the magnetic flux for recording generated by the thin film coil 19. Consequently, as described above, if the magnetic fluxes are generated in directions opposite to each other in the thin film coils 8 and 19 by passing currents to the thin film coils 8 and 19 in directions opposite to each other at the time of recording information, by the influence of the upward magnetic flux (magnetic flux for suppressing leakage) generated by the thin film coil 8, leakage of the downward magnetic flux (magnetic flux for recording) generated by the thin film coil 19 from the recording head portion 100B to the production head portion 100A is suppressed. Therefore, the magnetic flux for recording generated by the thin film coil 19 is efficiently emitted from the air bearing surface 50 via the main magnetic pole layer 15, so that the gradient and the strength of the perpendicular magnetic field can be increased also from this viewpoint.

The significance from the technical viewpoint of the thin film magnetic head according to the invention will now be described. Specifically, the structural characteristic of the thin film magnetic head of the invention is that the main magnetic pole layer 15 is receded from the write shield layer 40. The layout relation between the main magnetic pole layer 15 and the write shield layer 40 is a layout relation when the thin film magnetic head is not operated, that is, in a state where the thin film coils 8 and 19 are not energized, not a disposition relation when the thin film magnetic head is operated, that is, in a state the thin film coils 8 and 19 are energized. More concretely, an example of known modes in which the main magnetic pole layer 15 is receded from the write shield layer 40 is as follows. When a thin film magnetic head is constructed so that both of the main magnetic pole layer 15 and the write shield layer 40 are exposed in the air bearing surface 50, the main magnetic layer 15 and the write shield layer 40 are expanded due to the heat generated by passage of current to the thin film coils 8 and 19. As a result, the main magnetic pole layer 15 is unintentionally receded from the write shield layer 40. The phenomenon is generally known as a deficiency called “protrusion deficiency (so-called protrusion)” which occurs during the operation of the thin film magnetic head. However, the layout relation between the main magnetic pole layer 15 and the write shield layer 40 specified in the present invention is different from that at the time of occurrence of the protrusion deficiency but is a structural design specification of the thin film magnetic head. The layout relation of the present invention is directed to increase the gradient and the strength of the perpendicular magnetic field as much as possible. By making the main magnetic pole layer 15 intentionally receded from the write shield layer 40, the write shield layer 40 is exposed in the air bearing surface 50 while the main magnetic pole layer 15 is not exposed in the air bearing surface 50. Therefore, the thin film magnetic head according to the present invention has the technical significance from the viewpoint of increasing the gradient and the strength of the perpendicular magnetic field as much as possible by the design that the main magnetic pole layer 15 is receded from the write shield layer 40 at the time of non-operation. For information, in the case where the protrusion deficiency occurs in the thin film magnetic head, generally, heat tends to be accumulated in the main magnetic pole layer 15 more than the write shield layer 40. In other words, the main magnetic pole layer 15 tends to protrude more than the write shield layer 40. Considering the tendency, it is more obviously understood that the structural characteristic of the thin film magnetic head according to the invention is different from the structure eventually obtained due to the protrusion deficiency.

In the embodiment, as shown in FIG. 3, the end surface 15M in the main magnetic pole layer 15 has the bilaterally-symmetrical inverted-trapezoidal shape in plan view. The invention, however, is not always limited to the shape. The plan-view shape of the end surface 15M can be freely changed as long as the constructional conditions of the end surface 15M are satisfied. The constructional conditions are that the width W2 of the upper edge E2 is larger than the width W1 of the lower edge E1 and is equal to or larger than the width WD of the end surface 15M in an arbitrary intermediate position between the lower edge E1 and the upper edge E2 (W2>W1 and W2≧WD). For example, as shown in FIG. 6, in place of the bilaterally-symmetrical inverted-trapezoidal shape, the end surface 15M may have a bilaterally-symmetrical hexagon shape, more concretely, a hexagon shape in plan view obtained by combining an almost quadrangle shape positioned on the trailing side and an almost inverted-trapezoidal shape positioned on the leading side. In this case, for example, the width W2 of the upper edge E2 is equal to or larger than the width WD (W2≧WD). In this case as well, effects similar to those of the foregoing embodiment can be also obtained. The other configurations of the end surface 15M shown in FIG. 6 are similar to those shown in FIG. 3.

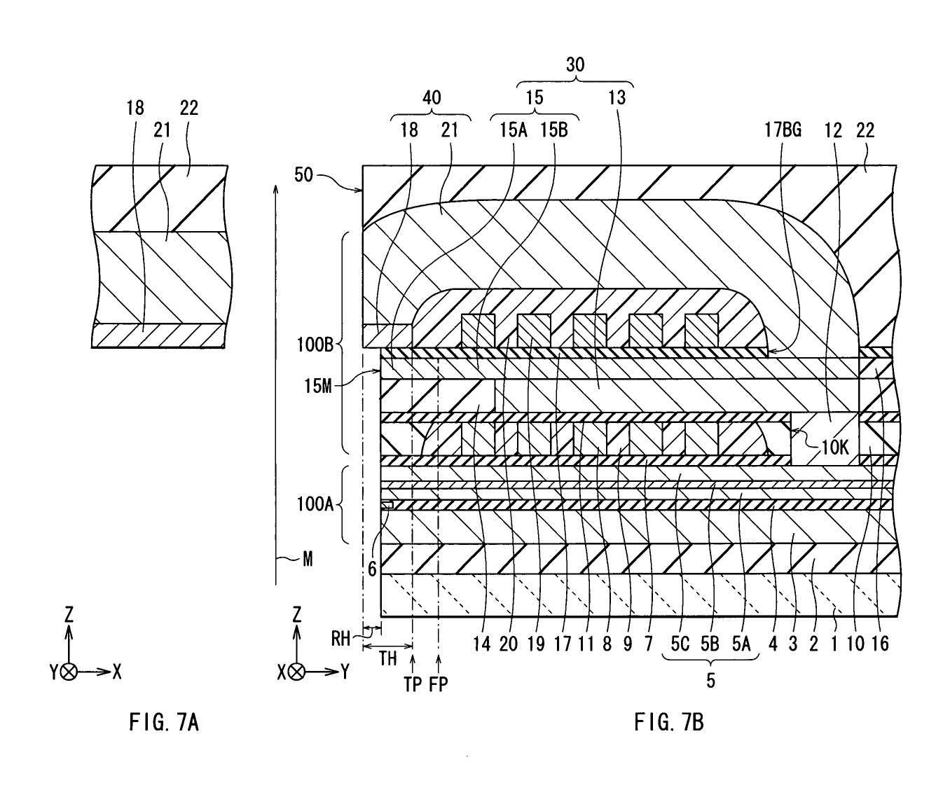

In the embodiment, as shown in FIG. 1B, the air bearing surface 50 is formed as a plane by the series of components from the substrate 1 to the overcoat layer 22. However, the invention is not limited to the configuration. The air bearing surface 50 may be also constructed as a plane only by a part of the series of components from the substrate 1 to the overcoat layer 22 and the rest of the components may be receded from the air bearing surface 50. For example, as shown in FIG. 7A and 7B, the air bearing surface 50 is constructed as a plane only by the write shield layer 40 (the TH specifying layer 18 and the yoke layer 21) and the overcoat layer 22 and the series of components from the substrate 1 to the gap layer 17 including the main magnetic pole layer 15 may be receded from the air bearing surface 50. In this case as well, effects similar to those of the foregoing embodiment can be obtained. The other configurations of the thin film magnetic head shown in FIG. 7A and 7B are similar to those shown in FIG. 1A and 1B.

When the components of the thin film magnetic head are partly receded from the air bearing surface 50 as shown in FIG. 7A and 7B, further, for example as shown in FIG. 8A and 8B, the protection film 23 may be provided so as to cover the air bearing surface 50 and the periphery. The protection film 23 is provided to protect the air bearing surface 50 physically and chemically and made of, for example, a high durable material such as diamond like carbon (DLC). In this case as well, effects similar to those of the foregoing embodiment can be obtained. The other configurations of the thin film magnetic head shown in FIGS. 8A and 8B are similar to those shown in FIG. 1A and 1B. Obviously, the protection film 23 described above can be applied not only to the thin film magnetic head shown in FIG. 7A and 7B but also to the thin film magnetic head shown in FIG. 1A and 1B.

The thin film magnetic head according to the embodiment have been described above.

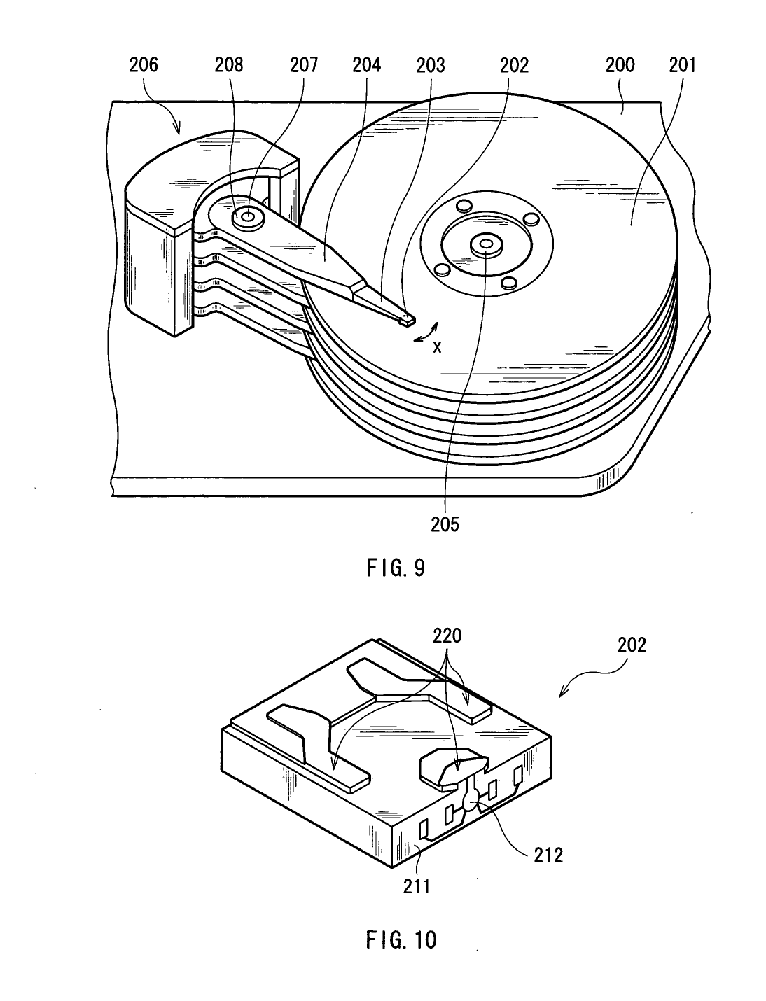

Next, with reference to FIGS. 9 and 10, the configuration of a magnetic recording apparatus on which the thin film magnetic head of the invention is mounted will be described. FIG. 9 shows a perspective view showing the configuration of the magnetic recording apparatus. FIG. 10 is an enlarged perspective view showing the configuration of a main part in the magnetic recording apparatus. The magnetic recording apparatus is an apparatus on which the thin film magnetic head described in the foregoing embodiment is mounted and is, for example, a hard disk drive.

The magnetic recording apparatus has, as shown in FIG. 9, for example, in a casing 200, a plurality of magnetic disks (such as hard disks) 201 as recording media on which information is magnetically recorded, a plurality of suspensions 203 disposed in correspondence with the magnetic disks 201 and each supporting a magnetic head slider 202 at its one end, and a plurality of arms 204 supporting the other ends of the suspensions 203. The magnetic disk 201 can rotate around a spindle motor 205 fixed to the casing 200 as a center. Each of the arms 404 is connected to a driving unit 206 as a power source and can swing via a bearing 208 around a fixed shaft 207 fixed to the casing 200 as a center. The driving unit 206 includes a driving source such as a voice coil motor. The magnetic recording apparatus is a model where, for example, a plurality of arms 204 can swing integrally around the fixed shaft 207 as a center. FIG. 9 shows the casing 200 which is partially cut away so that internal structure of the magnetic recording apparatus can be seen well.

The magnetic head slider 202 has a configuration such that, as shown in FIG. 10, a thin film magnetic head 212 executing both of recording and reproducing processes is attached to one of the faces of a substrate 211 having an almost rectangular parallelepiped shape and made of a nonmagnetic insulating material such as AlTic. The substrate 211 has, for example, one face (air bearing surface 220) including projections and depressions to decrease air resistance which occurs when the arm 204 swings. The thin film magnetic head 212 is attached to another face (the right front-side face in FIG. 10) orthogonal to the air bearing surface 220. The thin film magnetic head 212 has the configuration described in the foregoing embodiment. When the magnetic disk 201 rotates at the time of recording or reproducing information, the magnetic head slider 202 floats from the recording surface of the magnetic disk 201 by using an air current generated between the recording surface (the surface facing the magnetic head slider 202) of the magnetic disk 201 and the air bearing surface 220. FIG. 10 shows the upside down state of FIG. 9 so that the structure of the air bearing surface 220 of the magnetic head slider 202 can be seen well.

In the magnetic recording apparatus, at the time of recording or reproducing information, by swing of the arm 204, the magnetic head slider 202 moves to a predetermined region (recording region) in the magnetic disk 201. When current is passed to the thin film magnetic head 212 in a state where the thin film magnetic head 212 faces the magnetic disk 201, the thin film magnetic head 212 operates on the basis of the operation principle described in the foregoing embodiment and performs a recording or reproducing process on the magnetic disk 201.

In the magnetic recording apparatus, the thin film magnetic head 212 of the embodiment is mounted. Consequently, as described above, the gradient and the strength of the perpendicular magnetic field can be increased as much as possible.

The other configuration, operation, action, effects, and modification of the thin film magnetic head 212 mounted on the magnetic recording apparatus are similar to those of the foregoing embodiment, so that their description will not be repeated.

Next, examples of the present invention will be described.

The thin film magnetic head (refer to FIGS. 1A and 1B to FIG. 4; hereinbelow simply called “the thin film magnetic head of the invention”) described in the foregoing embodiment was mounted on the magnetic recording apparatus (refer to FIGS. 9 and 10). The recording process was executed on a recording medium by using the magnetic recording apparatus. At that time, the gradient and the strength of the perpendicular magnetic field were examined while changing the constructional condition of the thin film magnetic head (recess height RH), and the following series of results were obtained.

At the time of examining the gradient and the strength of the perpendicular magnetic field, as constructional conditions of the thin film magnetic head (refer to FIGS. 1A and 1B to FIG. 3), the saturated magnetic flux density of the main magnetic pole layer 15 was set to 2.0 T (tesla), the saturated magnetic flux density of the write shield layer 40 (TH specifying layer 18) was set to 1.5 T, the height T of the end surface 15M in the main magnetic pole layer 15 was set to 280 nm, the width W1 of the lower edge E1 was set to 51 nm, the width W2 of the upper edge E2 was set to 180 nm, the angle θ of inclination was set to 13°, the thickness of the gap layer 17 was set to 50 nm, and the length SH (=neck height NH) of the TH specifying layer 18 was set to 170 nm. In this case, a recording medium having a stacked layer configuration in which the base layer (soft magnetic layer: 150 nm thickness), the intermediate layer (10 nm thickness), the recording layer (perpendicular magnetic layer: 16 nm), and the protection layer (3 nm thickness) are stacked in this order is used. The distance between the recording medium (the protection layer as the outermost surface) and the thin film magnetic head (the main magnetic pole layer) was set to 11 nm.

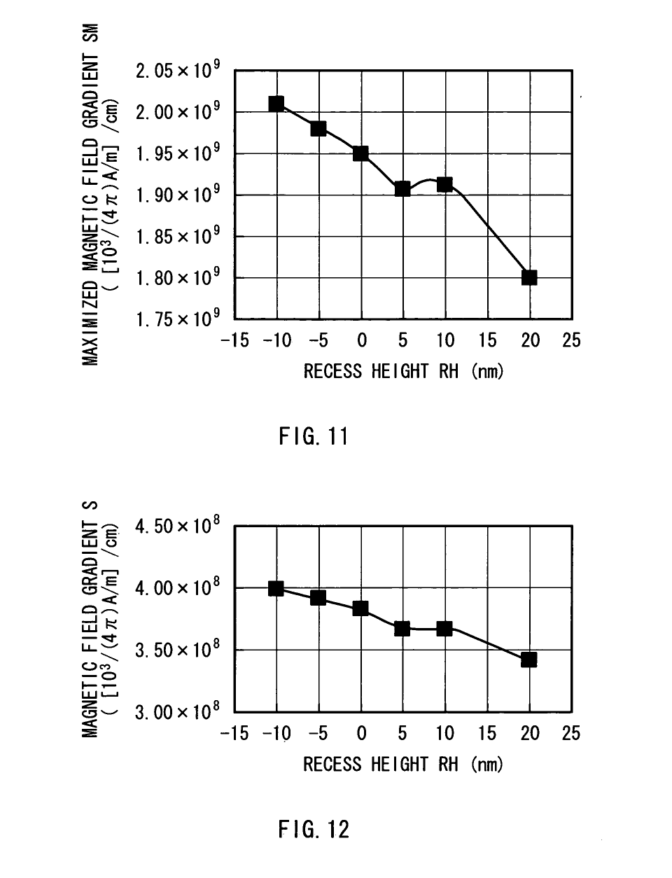

First, the correlation between the maximum gradient of the perpendicular magnetic field and the recess height was examined and results shown in FIG. 11 were obtained. FIG. 11 shows recess height dependency of the maximum magnetic field gradient. “Horizontal axis” indicates the recess height RH (nm) and “vertical axis” indicates the maximum magnetic field gradient SM ([10³/(4π)A/m(=Oe)]/cm). In FIG. 11, when the recess height RH is negative (SH<0), the main magnetic pole layer 15 is receded from the write shield layer 40 (the main magnetic pole layer 15 is receded from the air bearing surface 50 when the write shield layer 40 is exposed in the air bearing surface 50). On the other hand, when the recess height RH is positive (SH>0), the main magnetic pole layer 15 is protruded from the write shield layer 40 (the main magnetic pole layer 15 is protruded from the air bearing surface 50 when the write shield layer 40 is exposed in the air bearing surface 50). In particular, the case where the recess height RH is 0 shows the case where the main magnetic pole layer 15 is exposed together with the write shield layer 40 in the air bearing surface 50, that is, the state corresponding to the constructional condition of the thin film magnetic head of the comparative example shown in FIG. 5. The states according to the positive and negative values of the recess height RH are similar in FIG. 12 and the subsequent drawings.

As understood from the results shown in FIG. 11, when the recess height RH is changed in a range from −10 nm to 20 nm, the maximum magnetic field gradient SM gradually increases as the recess height RH shifts from the positive side to the negative side while having an inflection point around 8 nm of the recess height RH. Specifically, when the recess height RH is negative (SH<0), that is, the main magnetic pole layer 15 is receded from the write shield layer 40, the maximum magnetic field gradient SM continuously increases as the recess height RH decreases. Consequently, it was confirmed that by making the main magnetic pole layer 15 recede from the write shield layer 40, the maximum gradient of the perpendicular magnetic field increases.

Subsequently, the correlation between the magnetic field gradient and the recess height in the case where the strength of the perpendicular magnetic field is set to a specific value was examined, and results shown in FIG. 12 were obtained. FIG. 12 shows recess height dependency of the magnetic field gradient. “Horizontal axis” indicates the recess height RH (nm) and “vertical axis” indicates a magnetic field gradient S ([10³/(4π)A/m]/cm). At the time of examining the correlation between the magnetic field gradient and the recess height, the strength of the perpendicular magnetic field was set to 4500×10³/(4π)A/m, that is, the magnetic gradient S was measured at a recording point on the trailing edge where the magnetic field strength is 4500×10³/(4π)A/m.

As understood from the results shown in FIG. 12, the recess height RH was changed in a range from −10 nm to 20 nm, and the magnetic field gradient S behaves in a manner similar to the maximum magnetic field gradient SM in FIG. 11. Specifically, when the recess height RH is negative (SH<0), the magnetic field gradient S continuously increases as the recess height RH decreases. It was therefore confirmed that, in the thin film magnetic head of the invention, the gradient of the perpendicular magnetic field at the recording point increases by making the main magnetic pole layer 15 recede from the write shield layer 40.

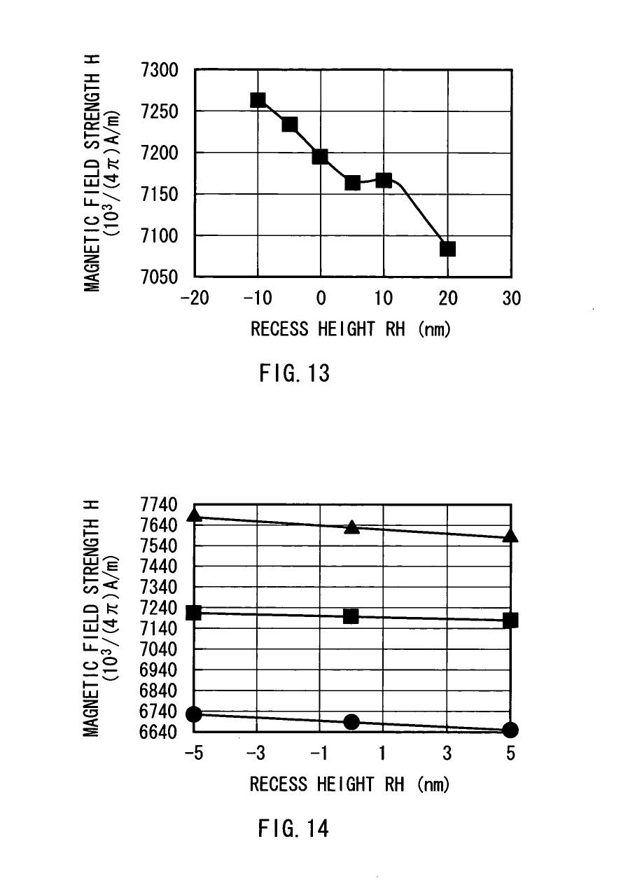

Subsequently, the correlation between the gradient of the perpendicular magnetic field and the recess height was examined, and results shown in FIG. 13 were obtained. FIG. 13 shows recess height dependency of the magnetic field strength. “Horizontal axis” indicates the recess height RH (nm) and “vertical axis” indicates a magnetic field strength H (10³/(4π)A/m). The magnetic field strength H is a value measured at a position corresponding to the recording point on the recording medium 60 (recording layer 62) shown in FIG. 4.

As understood from the results shown in FIG. 13, when the recess height RH was changed in a range from −10 nm to 20 nm, the magnetic field strength H behaves in a manner similar to the maximum magnetic field gradient SM in FIG. 11. Specifically, when the recess height RH is negative (SH<0), the magnetic field strength H continuously increases as the recess height RH decreases. It was therefore confirmed that the strength of the perpendicular magnetic field is increased by making the main magnetic pole layer 15 recede from the write shield layer 40.

The foregoing embodiment does not mention the influence exerted on the gradient and the strength of the perpendicular magnetic field in the case of changing each of, for example, the thickness of the gap layer 17, the thickness of the main magnetic pole layer 15, and the thickness of the TH specifying layer 18 in the write shield layer 40 at the time of examining the gradient and the strength of the perpendicular magnetic field. However, by making the main magnetic pole layer 15 recede from the write shield layer 40, also in the case where the thicknesses of the series of components fluctuate, although some variations may occur, the tendency that the gradient and the strength of the perpendicular magnetic field increase can certainly be obtained. For reference purposes, hereinbelow, results of the examination of the gradient and the strength of the perpendicular magnetic field in the case where each of the thickness of the gap layer 17 and the thickness of the main magnetic pole layer 15 is changed as representatives of the series of components will be described.

At the time of examining the gradient and the strength of the perpendicular magnetic field when each of the thickness of the gap layer 17 and the thickness of the main magnetic pole layer 15 is changed, as constructional conditions of the thin film magnetic head (refer to FIGS. 1A and 1B to FIG. 3), the saturated magnetic flux density of the main magnetic pole layer 15 was set to 2.0 T, the saturated magnetic flux density of the write shield layer 40 (TH specifying layer 18) was set to 1.5 T, the width W1 of the lower edge E1 was set to 51 nm, the width W2 of the upper edge E2 was set to 180 nm, the angle θ of inclination was set to 13°, the length SH of the TH specifying layer 18 was set to 170 nm, and the recess height RH of the main magnetic pole layer 15 was set to −5 nm.

First, the behaviors of the strength and the maximum gradient of the perpendicular magnetic field in the case where the thickness of the gap layer 17 is changed were examined and results shown in Tables 1 and 2 were obtained. Table 1 shows the behavior of the magnetic field strength. Table 2 shows the behavior of the maximum magnetic field gradient. In Tables 1 and 2, “comparative example” corresponds to the thin film magnetic head of the comparative example shown in FIG. 5 (the recess height RH=0 nm). “Present invention” corresponds to the thin film magnetic head of the invention shown in FIGS. 1A and 1B to FIG. 4 (the recess height RH=−5 nm).

TABLE 1

Magnetic field strength (10³/(4π)A/m)

| Thickness of gap | Comparative example | Present invention |
|---|---|---|
| layer (nm) | (RH = 0 nm) | (RH = −5 nm) |
| 100 | 7556 | 7586 |
| 50 | 7195 | 7227 |
| 10 | 6838 | 6877 |

TABLE 2

Maximum magnetic field gradient
([10³/(4π)A/m]/cm)

| Thickness of gap | Comparative example | Present invention |
|---|---|---|
| layer (nm) | (RH = 0 nm) | (RH = −5 nm) |
| 100 | 1.77 × 10⁹ | 1.78 × 10⁹ |
| 50 | 1.95 × 10⁹ | 1.98 × 10⁹ |
| 10 | 2.01 × 10⁹ | 2.36 × 10⁹ |

As understood from the results shown in Table 1, when the thickness of the gap layer 17 was changed in three levels of 10 nm, 50 nm, and 100 nm, the magnetic field strength increased in the present invention (RH=−5 nm) more than that in the comparative example (RH=0 nm) at any of the set values of the thickness of the gap layer 17. Further, as understood from the results shown in Table 2, when the thickness of the gap layer 17 was similarly changed in three levels of 10 nm, 50 nm and 100 nm the maximum magnetic field gradient similarly increased in the present invention (RH=−5 nm) more than that in the comparative example (RH=0 nm) at any of the set values of the thickness of the gap layer 17. It was consequently confirmed that in the thin film magnetic head of the invention, by making the main magnetic pole layer 15 recede from the write shield layer 40, the strength of the perpendicular magnetic field is increased irrespective of the thickness of the gap layer 17.

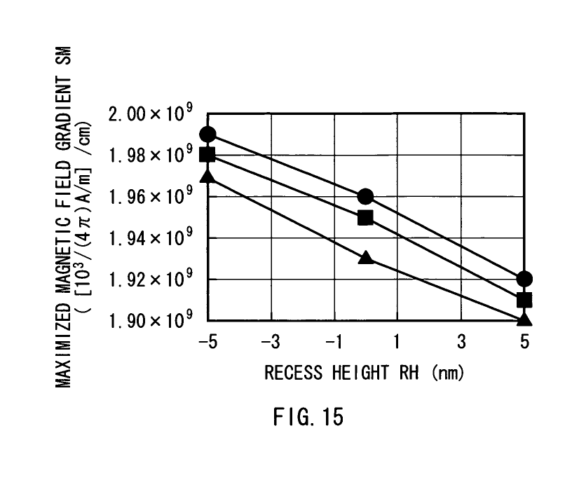

Subsequently, the behaviors of the strength and the maximum gradient of the perpendicular magnetic field in the case of changing the thickness of the main magnetic pole layer 15 were examined, and results shown in FIGS. 14 and 15 were obtained. FIG. 14 shows recess height dependency of the magnetic field strength. “Horizontal axis” indicates the recess height RH (nm) and “vertical axis” indicates a magnetic field strength H (10³/(4π)A/m). FIG. 15 shows recess height dependency of the maximum magnetic field gradient. “Horizontal axis” indicates the recess height RH (nm) and “vertical axis” indicates the maximum magnetic field gradient SM ([10³/(4π)A/m]/cm). In FIGS. 14 and 15, circles indicate the case where the thickness of the main magnetic pole layer 15 is 230 nm, squares indicate the case where the thickness of the main magnetic pole layer 15 is 280 nm, and triangles indicate the case where the thickness of the main magnetic pole layer 15 is 330 nm. Just for confirmation, in the data (the circles, squares, and triangles) shown in FIGS. 14 and 15, data of the recess height RH=−5 nm is of the thin film magnetic head of the present invention (FIGS. 1A and 1B to FIG. 4) and data of the recess distance RH of 0 nm is of the thin film magnetic head of the comparative example (refer to FIG. 5).

As understood from the results shown in FIG. 14, when the thickness of the main magnetic pole layer 15 was changed in three levels of 230 nm (circle), 280 nm (square), and 330 nm (triangle) in the case where the recess height RH was changed in the range from −5 nm to 5 nm, the magnetic field strength H in the invention (RH=−5 nm) was higher than that of the comparative example (RH=0 nm) at any of the set values of the thickness of the main magnetic pole layer 15. Further, as understood from the results shown in FIG. 15, when the thickness of the main magnetic pole layer 15 was changed in three levels of 230 nm (circle), 280 nm (square), and 330 nm (triangle) in the case where the recess height RH was similarly changed in the range from −5 nm to 5 nm, the maximum magnetic field gradient SM in the invention (RH=−5 nm) was similarly higher than that of the comparative example (RH=0 nm) at any of the set values of the thickness of the main magnetic pole layer 15. It was therefore confirmed that, in the thin film magnetic head of the invention, by making the main magnetic pole layer 15 recede from the write shield layer 40, the maximum magnetic filed gradient of the perpendicular magnetic field is increased irrespective of the thickness of the main magnetic pole layer 15.

Although the invention has been described above by the embodiment and the examples, the invention is not limited to the foregoing embodiment and examples but can be variously modified. Concretely, for example, although the case of applying the thin film magnetic head of the invention to a composite thin film magnetic head has been described in the foregoing embodiment and the examples, the invention is not limited to the case. The invention can be also applied to, for example, a recording-only thin film magnetic head having an inductive magnetic transducer for writing and a thin film magnetic head having an inductive magnetic transducer for recording and reproduction. Obviously, the invention can be also applied to a thin film magnetic head having a structure in which a device for writing and a device for reading are stacked in the order opposite to that of the thin film magnetic head of the embodiment. In any of those cases, effects similar to those of the foregoing embodiment can be obtained.

The thin film magnetic head according to the invention can be applied to, for example, a magnetic recording apparatus such as a hard disk drive for magnetically recording information onto a hard disk.

Obviously many modifications and variations of the present invention are possible in the light of the above teachings. It is therefore to be understood that within the scope of the appended claims the invention may be practiced otherwise than as specifically described.

What is claimed is:

1. A thin film magnetic head comprising:
a thin film coil that generates magnetic flux;
a magnetic pole layer which extends from a side close to a recording-medium-facing surface facing a recording medium traveling in a medium travel direction toward a side far from the recording-medium-facing surface, and generates a magnetic field for magnetizing the recording medium in a direction orthogonal to the surface of the recording medium on the basis of the magnetic flux generated by the thin film coil; and
a magnetic shield layer which extends from the side close to the recording-medium-facing surface toward the side far from the recording-medium-facing surface on the front side of the medium travel direction of the magnetic pole layer, is separated from the magnetic pole layer via a gap layer on the side close to the recording-medium-facing surface, and is coupled to the magnetic pole layer via a back gap on the side far from the recording-medium-facing surface,
wherein the magnetic pole layer recedes from the magnetic shield layer to the side far from the recording-medium-facing surface.

2. A thin film magnetic head according to claim 1, wherein a front end of the magnetic pole layer is positioned in a range where a portion separated from the magnetic pole layer via the gap layer in the magnetic shield layer extends.

3. A thin film magnetic head according to claim 1, wherein the magnetic shield layer is exposed in the recording-medium-facing surface, and the magnetic pole layer is not exposed in the recording-medium-facing surface.

4. A thin film magnetic head according to claim 1, wherein the magnetic pole layer has an end surface which is defined by a first edge positioned on the rear side in the medium travel direction and a second edge positioned on the front side in the medium travel direction in an end portion on the side close to the recording-medium-facing surface, and
width of the second edge in the end surface is larger than that of the first edge and is equal to or larger than that of the end surface in an arbitrary intermediate position between the first and second edges.

5. A thin film magnetic head comprising:
a magnetic pole layer that generates a recording magnetic field for magnetizing a recording medium in the perpendicular direction; and
a magnetic shield layer disposed on the front side in a recording medium travel direction of the magnetic pole layer,
wherein the magnetic pole layer recedes from the magnetic shield layer to the side apart from a recording-medium-facing surface.

6. A magnetic recording apparatus on which a recording medium and a thin film magnetic head for performing a magnetic process on the recording medium are mounted,
wherein the thin film magnetic head comprises:
a thin film coil that generates magnetic flux;
a magnetic pole layer which extends from a side close to a recording-medium-facing surface facing a recording medium traveling in a medium travel direction toward a side far from the recording-medium-facing surface and generates a magnetic field for magnetizing the recording medium in a direction orthogonal to the surface of the recording medium on the basis of the magnetic flux generated by the thin film coil; and
a magnetic shield layer which extends from the side close to the recording-medium-facing surface toward the side far from the recording-medium-facing surface on the front side in the medium travel direction of the magnetic pole layer, is separated from the magnetic pole layer via a gap layer on the side close to the recording-medium-facing surface, and is coupled to the magnetic pole layer via a back gap on the side far from the recording-medium-facing surface, and
the magnetic pole layer recedes from the magnetic shield layer to the side far from the recording-medium-facing surface.
